(19) United States
(12) Patent Application Publication
(10) Pub. No.: US 2026/0230614 A1
(43) Pub. Date: Aug. 6, 2026

(54) ENCODING METHOD, DECODING METHOD, DECODER, AND STORAGE MEDIUM

(71) Applicant: GUANGDONG OPPO MOBILE TELECOMMUNICATIONS CORP., LTD., Dongguan (CN)

(72) Inventor: Zhenyu DAI, Dongguan (CN)

(21) Appl. No.: 19/633,049

(22) Filed: Mar. 30, 2026

Related U.S. Application Data
(63) Continuation of application No. PCT/CN2023/123095, filed on Oct. 4, 2023.

(51) Int. Cl. H04N 19/117; H04N 19/172; H04N 19/70; H04N 19/82

(52) U.S. Cl. CPC H04N 19/117; H04N 19/172; H04N 19/70; H04N 19/82

(57) ABSTRACT

An encoding method, a decoding method, a decoder, and a storage medium are provided in embodiments of the disclosure. The decoding method includes the following. A bitstream is parsed to determine first information. A target value of a first scaling factor is determined from multiple candidate values of the first scaling factor according to the first information. A first residual picture is determined by performing loop filtering on a reconstructed picture according to a neural network. A loop-filtered reconstructed picture is determined by refining the first residual picture according to the target value of the first scaling factor.

### CROSS-REFERENCE TO RELATED APPLICATION(S)

This application is a continuation of International Application No. PCT/CN2023/123095, filed Oct. 4, 2023, the entire disclosure of which is hereby incorporated by reference.

### TECHNICAL FIELD

This disclosure relates to the field of video coding technology, in particular to an encoding method, a decoding method, a decoder, and a storage medium.

### BACKGROUND

A neural network based loop filter (NNLF) may refine a prediction residual picture of a neural network based on a derived scaling factor, and determine a loop-filtered reconstructed picture based on a refined residual picture.

However, a method for deriving a scaling factor provided in the related art results in an inaccurate value of the scaling factor, and thus the loop filtering quality is reduced.

### SUMMARY

In a first aspect, a decoding method is provided. The method is applied to a decoder and includes the following. A bitstream is parsed to determine first information. A target value of a first scaling factor is determined from multiple candidate values of the first scaling factor according to the first information. A first residual picture is determined by performing loop filtering on a reconstructed picture according to a neural network. A loop-filtered reconstructed picture is determined by refining the first residual picture according to the target value of the first scaling factor.

In a second aspect, an encoding method is provided. The method is applied to an encoder and includes the following. A reconstructed picture of an original picture is determined. A first residual picture is determined by performing loop filtering on the reconstructed picture according to a neural network. Multiple output pictures are determined by refining the first residual picture according to multiple candidate values of a first scaling factor. A target value of the first scaling factor is determined from the multiple candidate values according to the multiple output pictures.

In a third aspect, a decoder is provided. The decoder includes at least one processor and a memory. The memory is coupled to the at least one processor and stores at least one computer executable instruction thereon. When executed by the at least one processor, the at least one computer executable instruction causes the at least one processor to execute the method of the first aspect.

According to a fourth aspect, a non-transitory computer readable storage medium is provided in implementations. The non-transitory computer readable storage medium is configured to store a computer program which, when executed by a processor, causes the processor to execute the method of the second aspect.

### BRIEF DESCRIPTION OF THE DRAWINGS

FIG. 1 is a diagram of an example structure of a video encoder to which embodiments of the disclosure are applicable.

FIG. 2 is a diagram of an example structure of a video decoder to which embodiments of the disclosure are applicable.

FIG. 3 is a diagram of an example structure of a high-complexity neural network filter.

FIG. 4 is a diagram of an example structure of a low-complexity neural network filter.

FIG. 5 is a schematic diagram illustrating a filtering method for a neural network based loop filter (NNLF).

FIG. 6 is a schematic diagram illustrating a relationship between a residual between an original picture and a reconstructed picture and a prediction residual output by an NNLF.

FIG. 7 is a schematic flowchart of a decoding method provided in embodiments of the disclosure.

FIG. 8 is a schematic flowchart of an encoding method provided in embodiments of the disclosure.

FIG. 9 is a diagram of an example decoding framework provided in embodiments of the disclosure.

FIG. 10 is a schematic structural diagram of a decoder provided in an embodiment of the disclosure.

FIG. 11 is a schematic structural diagram of a decoder provided in another embodiment of the disclosure.

FIG. 12 is a schematic structural diagram of an encoder provided in an embodiment of the disclosure.

FIG. 13 is a schematic structural diagram of an encoder provided in another embodiment of the disclosure.

### DETAILED DESCRIPTION

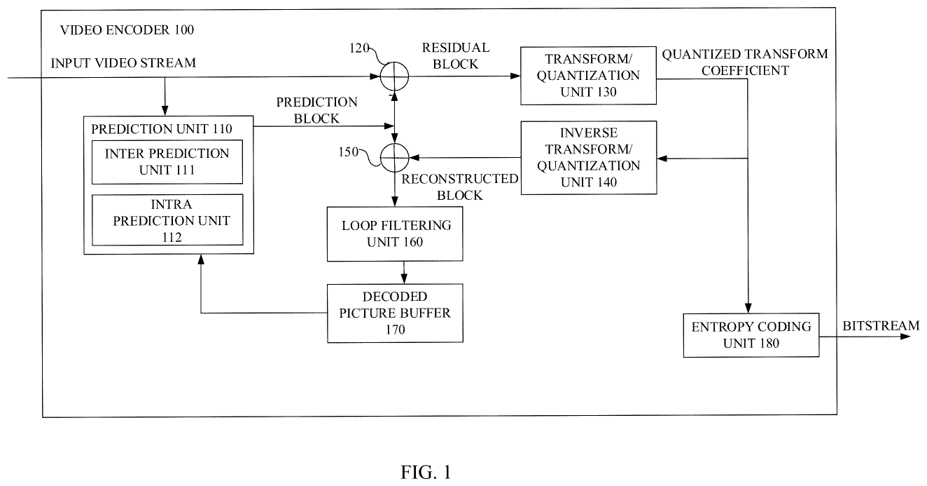

FIG. 1 is a schematic block diagram of a video encoder involved in embodiments of the disclosure.

It may be understood that, the video encoder 100 can be used for performing lossy compression or lossless compression on a picture. The lossless compression may be visually lossless compression or mathematically lossless compression.

The video encoder 100 may be applied to picture data in luma-chroma (YCbCr, YUV) format. For example, a YUV ratio may be 4:2:0, 4:2:2, or 4:4:4, where Y represents luminance (Luma), Cb (U) represents blue chrominance, and Cr (V) represents red chrominance. U and V represent chrominance (Chroma) for describing colour and saturation. For example, in terms of colour format, 4:2:0 represents that every 4 pixels have 4 luma components and 2 chroma components (YYYYCbCr), 4:2:2 represents that every 4 pixels have 4 luma components and 4 chroma components (YYYYCbCrCbCr), and 4:4:4 represents full pixel display (YYYYCbCrCbCrCbCrCbCr).

For example, the video encoder 100 reads video data, and for each picture in the video data, partitions the picture into several coding tree units (CTUs). In some examples, the CTU may be called “tree block”, “largest coding unit” (LCU), or “coding tree block” (CTB). Each CTU may be associated with a sample block of the same size as the CTU within the picture. Each pixel may correspond to one luminance (luma) sample and two chrominance (chroma) samples. Thus, each CTU may be associated with one luma sample block and two chroma sample blocks. The CTU may have a size of 128×128, 64×64, 32×32, and so on. The CTU may be further partitioned into several coding units (CUs) for coding. The CU may be a rectangular block or a square block. The CU may be further partitioned into a prediction unit (PU) and a transform unit (TU), so that coding, prediction, and transformation are separated, and thus processing is more flexible. In an example, the CTU is partitioned into CUs in a quadtree manner, and the CU is partitioned into TUs and PUs in a quadtree manner.

The video encoder and video decoder can support various PU sizes. Assuming that a size of a specific CU is 2N×2N, the video encoder and video decoder can support PUs of 2N×2N or N×N for intra prediction, and support symmetric PUs of 2N×2N, 2N×N, N×2N, N×N, or similar size for inter prediction. The video encoder and video decoder can also support asymmetric PUs of 2N×nU, 2N×nD, nL×2N, or nR×2N for inter prediction.

In some embodiments, as illustrated in FIG. 1, the video encoder 100 may include a prediction unit 110, a residual unit 120, a transform/quantization unit 130, an inverse transform/quantization unit 140, a reconstruction unit 150, a loop filtering unit 160, a decoded picture buffer 170, and an entropy coding unit 180. It may be noted that, the video encoder 100 may include more, less, or different functional components.

Optionally, in the disclosure, a current block may be referred to as a current CU or a current PU, etc. A prediction block may be referred to as a prediction picture block or a picture prediction block, and a reconstructed picture block may be referred to as a reconstructed block or a picture reconstructed block.

In some embodiments, the prediction unit 110 includes an inter prediction unit 111 and an intra prediction unit 112. Since there is a strong correlation between neighbouring samples in a video picture, intra prediction is used in the video coding technology to eliminate spatial redundancy between neighbouring samples. Since there is a strong similarity between neighbouring pictures in video, inter prediction is used in the video coding technology to eliminate temporal redundancy between neighbouring pictures, thereby improving coding efficiency.

The inter prediction unit 111 can be used for inter prediction. The inter prediction may include motion estimation and motion compensation, and reference can be made to picture information of different pictures. In inter prediction, motion information is used to find a reference block from a reference picture, and a prediction block is generated according to the reference block to eliminate temporal redundancy. In inter prediction, motion information is used to find the reference block from the reference picture, and the prediction block is generated according to the reference block. The motion information includes a reference picture list containing the reference picture, a reference picture index, and a motion vector. The motion vector may be an integer-sample motion vector or a fractional-sample motion vector. If the motion vector is the fractional-sample motion vector, interpolation filtering on the reference picture is required to generate a required fractional-sample block. Herein, an integer-sample block or fractional-sample block found in the reference picture according to the motion vector is called the reference block. In some technologies, the reference block may be called a prediction block, and in some technologies, the prediction block will be generated based on the reference block. Generating the prediction block based on the reference block can also be understood as taking the reference block as a prediction block and then processing to generate a new prediction block based on the prediction block.

The intra prediction unit 112 is configured to predict sample information of the current block only with reference to information of the same picture, so as to eliminate spatial redundancy.

There are multiple prediction modes for intra prediction. Taking international digital video coding standard H series as an example, H.264/AVC standard includes eight angular prediction modes and one non-angular prediction mode, and H.265/HEVC is extended to include 33 angular prediction modes and two non-angular prediction modes. Intra prediction modes used in HEVC include a planar mode, a direct current (DC) mode, and 33 angular modes, with a total of 35 prediction modes. Intra modes used in VVC include a planar mode, a DC mode, and 65 angular modes, with a total of 67 prediction modes.

It may be noted that with an increase in the number (quantity) of angular modes, intra prediction will be more accurate, which will be more in line with the demand for the development of high-definition and ultra-high-definition digital video.

The residual unit 120 may generate a residual block of the CU based on a sample block of the CU and a prediction block of a PU of the CU. For example, the residual unit 120 may generate the residual block of the CU such that each sample in the residual block has a value equal to a difference between a sample in the sample block of the CU and a corresponding sample in the prediction block of the PU of the CU.

The transform/quantization unit 130 may quantize a transform coefficient. The transform/quantization unit 130 may quantize a transform coefficient associated with a TU of a CU based on a quantization parameter (QP) value associated with the CU. The video encoder 100 may adjust the degree of quantization applied to a transform coefficient associated with the CU by adjusting the QP value associated with the CU.

The inverse transform/quantization unit 140 may perform inverse quantization and inverse transform respectively on the quantized transform coefficient, to reconstruct a residual block from the quantized transform coefficient.

The reconstruction unit 150 may add samples in the reconstructed residual block to corresponding samples in one or more prediction blocks generated by the prediction unit 110, to generate a reconstructed picture block associated with the TU. By reconstructing sample blocks of each TU of the CU in this way, the video encoder 100 can reconstruct the sample block of the CU.

The loop filtering unit 160 is configured to process an inverse-transformed and inverse-quantized sample, compensate distorted information, and provide a better reference for subsequent sample encoding. For example, the loop filtering unit 160 can perform deblocking filtering operations to reduce blocking artifacts of the sample block associated with the CU.

In some embodiments, the loop filtering unit 160 includes a deblocking filtering unit and a sample adaptive offset/adaptive loop filter (SAO/ALF) unit, where the deblocking filtering unit is configured for deblocking, and the SAO/ALF unit is configured to remove a ringing effect.

The decoded picture buffer 170 may store reconstructed sample blocks. The inter prediction unit 111 may use reference pictures containing reconstructed sample blocks to perform inter prediction on PUs of other pictures. In addition, the intra prediction unit 112 may use the reconstructed sample blocks in the decoded picture buffer 170 to perform intra prediction on other PUs in the same picture as the CU.

The entropy coding unit 180 may receive the quantized transform coefficient from the transform/quantization unit 130. The entropy coding unit 180 may perform one or more entropy coding operations on the quantized transform coefficient to generate entropy-coded data.

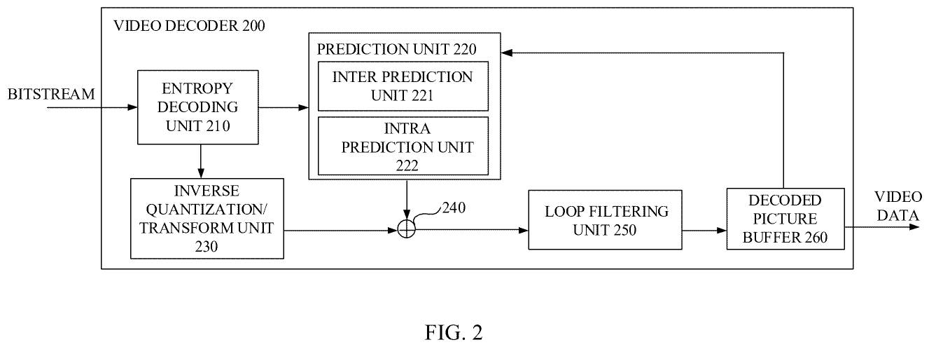

FIG. 2 is a schematic block diagram of a video decoder involved in embodiments of the disclosure.

As illustrated in FIG. 2, the video decoder 200 includes an entropy decoding unit 210, a prediction unit 220, an inverse quantization/transform unit 230, a reconstruction unit 240, a loop filtering unit 250, and a decoded picture buffer 260. It may be noted that, the video decoder 200 may include more, less, or different functional components.

The video decoder 200 may receive a bitstream. The entropy decoding unit 210 may parse the bitstream to extract syntax elements from the bitstream. As part of parsing the bitstream, the entropy decoding unit 210 may parse entropy-coded syntax elements in the bitstream. The prediction unit 220, the inverse quantization/transform unit 230, the reconstruction unit 240, and the loop filtering unit 250 may decode video data according to the syntax elements extracted from the bitstream, that is, generate decoded video data.

In some embodiments, the prediction unit 220 includes an intra prediction unit 222 and an inter prediction unit 221.

The intra prediction unit 222 may perform intra prediction to generate a prediction block of a PU. The intra prediction unit 222 may use an intra prediction mode to generate a prediction block of the PU based on a sample block of spatially neighbouring PUs. The intra prediction unit 222 may also determine an intra prediction mode for the PU according to one or more syntax elements parsed from the bitstream.

The inter prediction unit 221 can construct a first reference picture list (list 0) and a second reference picture list (list 1) according to the syntax elements parsed from the bitstream. In addition, the entropy decoding unit 210 may parse motion information of the PU if the PU is encoded using inter prediction. The inter prediction unit 221 may determine one or more reference blocks of the PU according to the motion information of the PU. The inter prediction unit 221 may generate a prediction block of the PU based on one or more reference blocks of the PU.

The inverse quantization/transform unit 230 may perform inverse quantization on (i.e., dequantize) a transform coefficient associated with a TU. The inverse quantization/transform unit 230 may use a QP value associated with a CU of the TU to determine the degree of quantization.

After inverse quantization of the transform coefficient, the inverse quantization/transform unit 230 may perform one or more inverse transformations on the inverse-quantized transform coefficients, to generate a residual block associated with the TU.

The reconstruction unit 240 uses the residual block associated with the TU of the CU and the prediction block of the PU of the CU to reconstruct a sample block of the CU. For example, the reconstruction unit 240 may add samples in the residual block to corresponding samples in the prediction block to reconstruct the sample block of the CU to obtain the reconstructed picture block.

The loop filtering unit 250 may perform deblocking filtering to reduce blocking artifacts of the sample block associated with the CU.

The video decoder 200 may store the reconstructed picture of the CU in the decoded picture buffer 260. The video decoder 200 may use the reconstructed picture in the decoded picture buffer 260 as a reference picture for subsequent prediction, or transmit the reconstructed picture to a display apparatus for display.

A basic process of video coding is as follows. At the encoding end, a picture is partitioned into blocks, and for a current block, the prediction unit 110 performs intra prediction or inter prediction to generate a prediction block of the current block. Based on the prediction block and an original block of the current block, the residual unit 120 may calculate a residual block, i.e., a difference between the prediction block and the original block of the current block. The residual block may also be referred to as residual information. The residual block can be transformed and quantized by the transform/quantization unit 130 to remove information that is not sensitive to human eyes, so as to eliminate visual redundancy. Optionally, the residual block before being transformed and quantized by the transform/quantization unit 130 may be called a time-domain residual block, and the time-domain residual block after being transformed and quantized by the transform/quantization unit 130 may be called a frequency residual block or a frequency-domain residual block. The entropy coding unit 180 receives a quantized transform coefficient output by the transform/quantization unit 130, and may perform entropy coding on the quantized transform coefficient to output a bitstream. For example, the entropy coding unit 180 can eliminate character redundancy according to a target context model and probability information of a binary bitstream.

At the decoding end, the entropy decoding unit 210 may parse the bitstream to obtain prediction information, a quantization coefficient matrix, etc., of a current block, and the prediction unit 220 performs intra prediction or inter prediction on the current block based on the prediction information to generate a prediction block of the current block. The inverse quantization/transform unit 230 uses the quantization coefficient matrix obtained from the bitstream to perform inverse quantization and inverse transform on the quantization coefficient matrix to obtain a residual block. The reconstruction unit 240 adds the prediction block and the residual block to obtain a reconstructed block. The reconstructed blocks form a reconstructed picture. The loop filtering unit 250 performs loop filtering on the reconstructed picture on a picture basis or on a block basis to obtain a decoded picture. Similar operations for obtaining the decoded picture at the decoding end are also needed at the encoding end. The decoded picture may also be referred to as a reconstructed picture, and the reconstructed picture may be a reference picture of a subsequent picture for inter prediction.

It may be noted that, block partition information determined at the encoding end, as well as mode information or parameter information for prediction, transformation, quantization, entropy coding, loop filtering, etc., are carried in the bitstream when necessary. The decoding end parses the bitstream and analyzes existing information to determine the block partition information, as well as the mode information or the parameter information for prediction, transformation, quantization, entropy coding, loop filtering, etc. the same as such information at the encoding end, so as to ensure that the decoded picture obtained by the encoding end is the same as the decoded picture obtained by the decoding end.

The above is the basic process of the video codec under a block-based hybrid coding framework. With the development of technology, some modules or operations of the framework or process may be optimized. This disclosure is applicable to the basic process of the video codec under the block-based hybrid coding framework, but is not limited to the framework and process.

The coding framework provided in embodiments of the disclosure are described in detail above. Embodiments of the disclosure are applicable to loop filtering units in the coding framework. The loop filtering operations will be introduced in detail below.

In video coding standards, such as versatile video coding (VVC), a loop filtering unit may include filtering tools such as a deblocking filter (DBF), an SAO, and an ALF.

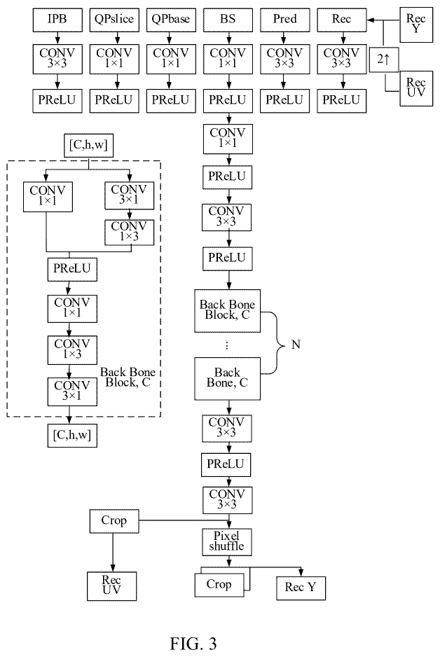

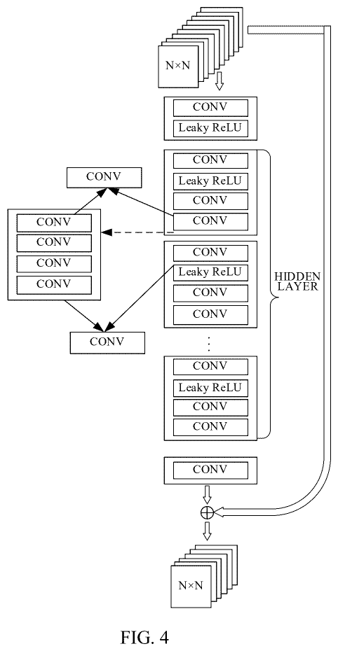

In recent years, with the development of deep learning technology, the exploration of a neural network based loop filter (NNLF) has been gradually carried out. After years of continuous research and optimization, two NNLFs are used as baseline filtering tools for neural network based video coding (NNVC) common reference software. Of these two NNLFs, one is a high-complexity neural network filter, and the other is a low-complexity neural network filter. The high-complexity neural network filter is generally referred to as a high operation point (HOP), and a possible structure of this filter is illustrated in FIG. 3. The low-complexity neural network filter is generally referred to as a low operation point (LOP), and a possible structure of this filter is illustrated in FIG. 4.

A structure of a residual network is used for both the HOP and the LOP. Luma information and chroma information of a reconstructed picture are used as the input to the network together with various auxiliary information, such as deblocking filtering boundary strength information, QP information, and the like, and there is a skip-connection structure between the input to and the output of the network. The output of the network is a prediction residual picture, which is added to the input reconstructed picture to obtain a filtered reconstructed picture.

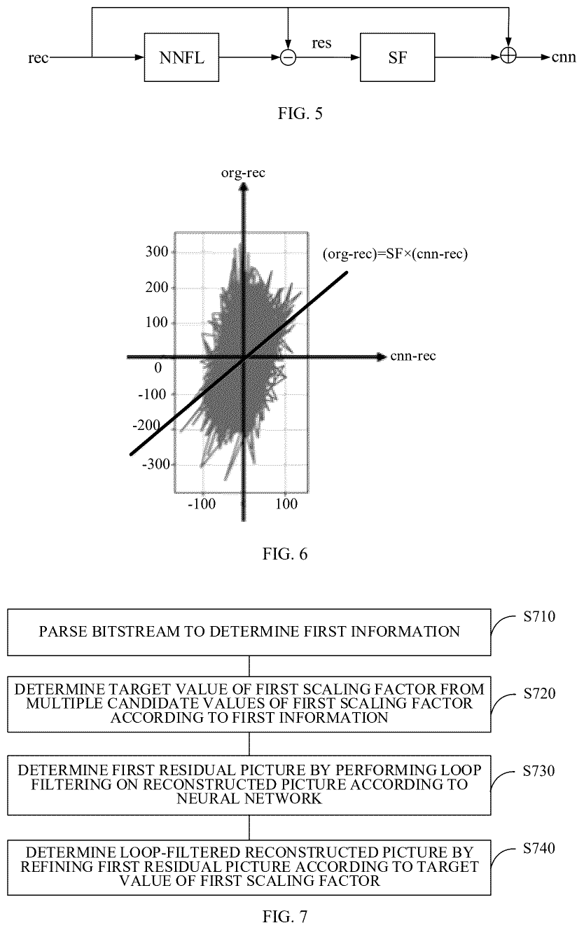

For the prediction residual picture output by the network, an artificially-defined picture-level scaling factor (SF) is introduced in both the HOP and the LOP to scale a residual, so that a final output picture is closer to an original picture, thereby bringing better coding performance, as illustrated in FIG. 5.

In the HOP and the LOP, based on the least squares method, a certain calculation formula is defined for deriving a scaling factor. The derivation of the scaling factor provided in the related art will be described in detail below.

It is assumed that a picture has the width of W and the height of H, and P(x, y) represents the coordinates of a pixel P. A reconstructed picture input to a neural network is rec(x, y), a residual picture output by the neural network is res(x, y), a filtered picture finally output by the neural network is cnn(x, y), and an original picture is org(x, y).

For a picture-level scaling factor, a residual between corresponding pixels of two pictures is first calculated based on formula 1 and formula 2 below.

$$orgResi ( {x}_{i} , {y}_{i} ) = [ org ( {x}_{i} , {y}_{i} ) - r e c ( {x}_{i} , {y}_{i} ) ] \qquad ( Formula 1 )$$

$$cnnResi ( {x}_{i} , {y}_{i} ) = [ c n n ( {x}_{i} , {y}_{i} ) - r e c ( {x}_{i} , {y}_{i} ) ] \qquad ( Formula 2 )$$

Then, based on formula 3 to formula 6, by traversing all pixels of a current picture, residual related information of the whole picture is obtained according to various forms of weighted sums.

$$sum\_orgResi = {\sum }_{{x}_{1}}^{W} {\sum }_{{y}_{1}}^{H} orgResi ( {x}_{i} , {y}_{i} ) \qquad ( Formula 3 )$$

$$sum\_orgResi = {\sum }_{{x}_{1}}^{W} {\sum }_{{y}_{1}}^{H} cnnResi ( {x}_{i} , {y}_{i} ) \qquad ( Formula 4 )$$

$$sum\_cnnMulti = {\sum }_{{x}_{1}}^{W} {\sum }_{{y}_{1}}^{H} ( cnnResi ( {x}_{i} , {y}_{i} ) * cnnResi ( {x}_{i} , {y}_{i} ) ) \qquad ( Formula 5 )$$

$$sum\_crossMulti = {\sum }_{{x}_{1}}^{W} {\sum }_{{y}_{1}}^{H} ( c n n Resi ( {x}_{i} , {y}_{i} ) * orgResi ( {x}_{i} , {y}_{i} ) ) \qquad ( Formula 6 )$$

Finally, as illustrated in formula 7, a one-dimensional scaling factor at the picture-level is statistically calculated based on the least squares method. SF_{bottom} and SFᵤₚ are an artificially-defined lower limit value and upper limit value, respectively.

$$SF = clip ( {SF}_{b o t t o m} , {SF}_{u p} , \frac{\begin{matrix}W * H * sum\_crossMulti - \\ sum\_orgResi * sum\_cnnResi\end{matrix}}{\begin{matrix}W * H * sum\_cnnMulti - \\ sum\_cnnResi * sum\_cnnResi\end{matrix}} )$$

Based on the derived scaling factor, a residual between the reconstructed picture and the filtered picture is refined to obtain a final output picture output(xᵢ, yᵢ), as illustrated in formula 8. First, the scaling factor itself needs to be encoded with a certain number of bits after being derived at the encoding end, and then can be used after being parsed at the decoding end.

$$output ( {x}_{i} , {y}_{i} ) = r e c ( {x}_{i} , {y}_{i} ) + SF * [ cnn ( {x}_{i} , {y}_{i} ) - r e c ( {x}_{i} , {y}_{i} ) ] \qquad ( Formula 8 )$$

During the current calculation of the scaling factor, it is assumed that a prediction residual output by an NNLF and a residual between the original picture and the reconstructed picture accord with a linear distribution law, and then the least squares method is used for fitting and solving, as illustrated in formula 9.

$$\frac{org - rec}{c n n - r e c} = S F \qquad ( Formula 9 )$$

However, as illustrated in FIG. 6, through the analysis of the distribution of residuals based on simulation experiments and data statistics, it is found that the residual between the original picture and the reconstructed picture and the prediction residual output by the NNLF do not accord with a simple linear law and are difficult to be fitted using a single function curve.

In statistics, the Pearson correlation coefficient (PCC) can be used for measuring a correlation (linear correlation) between two samples X and Y, and a calculation form thereof is a quotient of a covariance and a standard deviation between the two samples, as illustrated in formula 10. X̅ and Y̅ represent respective average values of the two samples.

$$r = \frac{c o v ( X , Y )}{σ X σ Y} = \frac{{\sum }_{i = 1}^{n} ( {X}_{i} - \overline{X} ) ( {Y}_{i} - \overline{Y} )}{\sqrt{{\sum }_{i = 1}^{{n}_{1}} {( {X}_{i} - \overline{X} )}^{2}} \sqrt{{\sum }_{i = 1}^{n} {( {Y}_{i} - \overline{Y} )}^{2}}} \qquad ( Formula 10 )$$

According to the definition of the PCC, when |r|>0.5, it indicates that the two samples satisfy a certain linear relationship, making linear regression worthwhile. However, through calculation of the residual between the original picture and the reconstructed picture as well as a PCC between this residual and the prediction residual output by the NNLF, it is found that a value of the PCC between the two is about 0.25, which indicates that a relationship between the two is not a simple linear relationship. Therefore, the derivation of the scaling factor by using the least squares method is inaccurate.

Based on this, an encoding method is proposed in embodiments of the disclosure. The method includes the following. A reconstructed picture of an original picture is determined. A first residual picture is determined by performing loop filtering on the reconstructed picture according to a neural network. Multiple output pictures are determined by refining the first residual picture according to multiple candidate values of a first scaling factor. A target value of the first scaling factor is determined from the multiple candidate values according to the multiple output pictures.

In addition, a decoding method is further proposed in embodiments of the disclosure. The method includes the following. A bitstream is parsed to determine first information. A target value of a first scaling factor is determined from multiple candidate values of the first scaling factor according to the first information. A first residual picture is determined by performing loop filtering on a reconstructed picture according to a neural network. A loop-filtered reconstructed picture is determined by refining the first residual picture according to the target value of the first scaling factor.

As can be seen from the above contents, in embodiments of the disclosure, a target value of a scaling factor is determined from multiple candidate values of the scaling factor according to refinement results of the multiple candidate values, thereby making a value of the scaling factor more accurate and contributing to improving the loop filtering quality.

The following will first provide detailed illustrative examples of a decoding method provided in embodiments of the disclosure.

FIG. 7 is a schematic flowchart of a decoding method provided in embodiments of the disclosure. The method in FIG. 7 may also be referred to as a loop filtering method. The method in FIG. 7 may be applied to a decoder, for example, a loop filtering unit in the decoder.

As illustrated in FIG. 7, in operations at S710 and S720, a bitstream is parsed to determine first information, and a target value of a first scaling factor is determined from multiple candidate values of the first scaling factor according to the first information.

In some implementations, the first scaling factor may be referred to as a refined scaling factor (RSF).

In some implementations, the first scaling factor may correspond to one picture. Therefore, the first scaling factor may correspond to a current picture. The first scaling factor may be referred to as a picture-level scaling factor.

In some implementations, the first scaling factor may correspond to one colour component (or colour channel), and different colour components may correspond to different first scaling factors. For example, if colour information of a pixel is represented by three colour components Y, Cb, and Cr, then each of Y, Cb, and Cr may have a corresponding first scaling factor. For another example, if colour information of a pixel is represented by two colour channels: luma and chroma channels, then each of the two colour channels: luma and chroma channels may have a corresponding first scaling factor.

In some implementations, the first scaling factor may correspond to one block in the picture. Therefore, the first scaling factor may correspond to a current block.

In some implementations, the target value of the first scaling factor may be determined based on the multiple candidate values of the first scaling factor (for example, selected from the multiple candidate values).

In some implementations, the multiple candidate values of the first scaling factor are predefined values. For example, the number and values of candidate values of the first scaling factor may be agreed upon according to a standard.

In some implementations, the multiple candidate values of the first scaling factor may be determined based on a certain rule. For example, the multiple candidate values of the first scaling factor may be determined based on: a traversal in a value range of the first scaling factor according to a traversal step (the above traversal may be implemented at the encoding end, and the decoding end may directly determine a value of the first scaling factor according to information in the bitstream).

In some implementations, for the above traversal, a certain boundary value (for example, an upper limit value or a lower limit value) of the first scaling factor may be used as an initial value.

Exemplarily, assuming that a value range of an RSF (i.e., the first scaling factor) is (SF_{bottom}, SFᵤₚ) and a traversal step is d, then the number of required traversals is

$$K = \frac{S {F}_{u p} - S {F}_{b o t t o m}}{d}$$

(where if

$$\frac{S {F}_{u p} - S {F}_{b o t t o m}}{d}$$

is not an integer,

$$\frac{S {F}_{u p} - S {F}_{b o t t o m}}{d}$$

may be rounded down), and a candidate value of RSFᵢ obtained in the i-th traversal is SF_{bottom}+i*d. By substituting RSFᵢ into formula 8 mentioned above, an output picture corresponding to RSFᵢ can be obtained. Then, the output picture corresponding to RSFᵢ can be compared with an original picture, and a distortion cost Dᵢ corresponding to RSFᵢ can be calculated.

The minimum distortion cost Dᵢ corresponding to the RSF is calculated through K traversals. Then, a value of the RSF corresponding to the minimum distortion cost Dᵢ may be determined as a target value of the RSF.

The above derivation method may be implemented by using the following pseudo code:

int RSF = 0;
double minD = MAX_DOUBLE;
For (int i=0; i<K; i++)
{
RSFᵢ = SF_{bottom}+ i * d;
outputᵢ = rec + RSFᵢ * (cnn - rec);
Dᵢ = MSE(org, outputᵢ);
if(Dᵢ < minD)
{
minD = Dᵢ;
RSF = RSFᵢ;
}
}

For the meaning of each parameter in the above pseudo code, reference can be made to the related illustration of formulas 1 to 8 above, and MSE(⋅) represents solving a least mean squared error.

The above traversal step may be a fixed step. Alternatively, in some implementations, the above traversal step may be a non-fixed step (i.e., including traversal steps of non-equal lengths). For example, a value range of the first scaling factor may include a first value interval and a second value interval, the first value interval corresponds to a first traversal step, the second value interval corresponds to a second traversal step, and the first traversal step is different from the second traversal step. The use of different traversal steps contributes to improving the coding performance, and for details, reference can be made to the following illustration of the encoding side.

In some implementations, the first information (which may be represented by picture_rsf_value) is used for determining the target value of the first scaling factor.

In some implementations, the first information is the target value of the first scaling factor. That is, the value of the first scaling factor may be directly carried in the bitstream.

In some implementations, the first information may be index information of the target value of the first scaling factor in the multiple candidate values of the first scaling factor. For example, if there are 10 candidate values of the first scaling factor, and the first information is the third candidate value among the 10 candidate values, then a value of the first information may be 3. Compared with directly carrying the value of the first scaling factor in the bitstream, carrying the index information can reduce the number of encoded bits required for carrying the first scaling factor in the bitstream.

In some implementations, the first information indicates or is used for determining the number of traversals corresponding to the first scaling factor (where the number of traversals can be understood as an implementation of the index information). For example, if the encoding end determines candidate values of the first scaling factor based on the above traversal, the first information may indicate the number of traversals corresponding to the first scaling factor. After the number of traversals corresponding to the first scaling factor is determined, the target value of the first scaling factor may be determined according to an initial value (which may be a certain boundary value, such as an upper limit value or a lower limit value, of the first scaling factor) of the first scaling factor, the traversal step, and the number of traversals.

For example, assuming that a candidate value of RSF, obtained in the i-th traversal may be SF_{bottom}+i*d, and a target value of an RSF is a candidate value RSFₖ obtained in the k-th traversal, then the first information may indicate a value of k. As such, at the decoding end, the target value of the RSF may be determined based on SF_{bottom}+k*d.

In the related art, for a calculated value of a scaling factor, N (N=9) bits are needed to directly encode the value of the scaling factor. Different from the related art, the concept of a traversal step is introduced in embodiments of the disclosure. Therefore, a quantization scale may be scaled up, and only the number of traversals needs to be encoded. Compared with directly encoding the value of the scaling factor, encoding the number of traversals can reduce encoded bits required for the scaling factor. A method for calculating the number of encoded bits for the first scaling factor is illustrated in formula 11.

$$M = {log}_{2}^{k} \qquad ( Formula 11 )$$

In the above, M represents the number of encoded bits for the first scaling factor, and k represents the number of traversals corresponding to the first scaling factor (i.e., the target value of the first scaling factor is obtained through k traversals).

In operations at S730, a first residual picture is determined by performing loop filtering on a reconstructed picture according to a neural network.

In some implementations, the neural network may be an HOP.

In some implementations, the neural network may be an LOP.

In some implementations, the reconstructed picture may be a picture.

In some implementations, the reconstructed picture may be a block in the picture.

In some implementations, the first residual picture may be referred to as a prediction residual picture of the neural network.

In some implementations, the operations at S730 may include the following. A filtered picture is determined by performing loop filtering on the reconstructed picture according to the neural network. The first residual picture is determined according to the filtered picture and the reconstructed picture. The filtered picture mentioned herein refers to a picture output by the neural network.

In some implementations, the first residual picture may be determined according to the filtered picture and the reconstructed picture as follows. A difference (i.e., a difference calculated for corresponding pixels) between the filtered picture and the reconstructed picture is determined as the first residual picture.

In operations at S740, a loop-filtered reconstructed picture is determined by refining the first residual picture according to the target value of the first scaling factor.

In some implementations, first, a refined residual picture may be determined by refining the first residual picture according to the target value of the first scaling factor. Then, the loop-filtered reconstructed picture is determined according to the refined residual picture and the reconstructed picture.

In some implementations, the refined residual picture may be determined by refining the first residual picture according to the target value of the first scaling factor as follows. Each pixel in the first residual picture is scaled according to the target value of the first scaling factor (i.e., each pixel in the first residual picture is multiplied by the first scaling factor), to determine the refined residual picture.

In some implementations, the loop-filtered reconstructed picture may be determined according to the refined residual picture and the reconstructed picture as follows. The refined residual picture and the reconstructed picture are summed (corresponding pixels are summed), and a summation result is determined as the loop-filtered reconstructed picture.

In some implementations, the bitstream may be parsed to determine second information. The second information indicates whether the first residual picture is to be refined based on the first scaling factor. In other words, the second information may indicate whether the RSF provided in embodiment of the disclosure is to be used for loop filtering.

In some implementations, for example, the second information may be represented by picture_rsf_enable_flag. The second information may have a first value and a second value. For example, the first value may be true or 1. The first value may indicate that the first residual picture is to be refined based on the first scaling factor. For example, the second value may be false or 0. The second value may indicate that the first residual picture is not to be refined based on the first scaling factor.

In some implementations, if the first residual picture is not to be refined based on the first scaling factor, the first residual picture may be refined based on a scaling factor provided in the related art. In embodiments of the disclosure, the scaling factor provided in the related art is referred to as a second scaling factor, and a method for determining a value of the second scaling factor is different from a method for determining the value of the first scaling factor. The value of the second scaling factor may be determined based on the least squares method, and for the detailed illustration, reference can be made to formulas 1 to 8 above. Accordingly, if the second scaling factor is to be used for refining the first residual picture, the bitstream may be parsed to determine third information. The third information may be a target value of the second scaling factor.

Embodiments of the disclosure will be described in more detail below in combination with a specific example. The following example is applicable to a loop filtering unit at the decoding end. It may be noted that, the following example is merely illustrated for helping those skilled in the art to understand embodiments of the disclosure, and is not intended to limit embodiments of the disclosure to specific values or specific scenarios as illustrated. Apparently, various equivalent modifications or changes can be made by those skilled in the art based on the example illustrated, and those modifications or changes also fall within the scope of embodiments of the disclosure.

A decoder obtains and parses a bitstream. When the parsing proceeds to a loop filtering unit, processing may be performed in an order of filters (for example, a DBF, an SAO, and other filters) specified by the loop filtering unit. When the process reaches a scaling-factor refinement unit, processing may be performed according to a procedure.

Step a): For a current colour component of a current picture of a current sequence, a picture-level scaling-factor refinement enable flag picture_rsf_enable_flag may be parsed. If picture_rsf_enable_flag is “1”, picture_rsf_value of an RSF (corresponding to the above first scaling factor) may be further parsed. If picture_rsf_enable_flag is “0”, a target value picture_sf_value of an SF (corresponding to the above second scaling factor) may be further parsed. After step a) is performed, the process proceeds to step b).

Step b): For the current colour component of the current picture of the current sequence, a residual (corresponding to the above first residual picture) between a reconstructed picture and a filtered picture is refined based on formula 8, to obtain an output picture. After step b) is performed, the process proceeds to step c).

Step c): If the processing of the current picture by the scaling-factor refinement unit has been completed, a next picture is loaded and the process proceeds to step a) for further processing.

A picture header may be defined as follows.

| | Descriptor |
|---|---|
| picture_header( ) { | |
| ... ... | ... ... |
| for (Idx=0; Idx<N; Idx++) { | |
| picture_rsf_enable_flag[Idx] | u(1) |
| if(picture_rsf_enable_flag[Idx]) { | |
| picture_rsf_value[Idx] | ue(v) |
| } | |
| else{ | |
| picture_sf_value[Idx] | ue(v) |
| } | |
| } | |
| } | |
| ... ... | |

In the syntax of the picture header, picture_rsf_enable_flag[N] indicates a picture-level scaling-factor refinement enable flag. When picture_rsf_enable_flag is 1, it indicates that an RSF is enabled. When picture_rsf_enable_flag is 0, it indicates that the RSF is disabled, and in this case, an SF may be used. In addition, in this picture header, picture_rsf_value[N] and picture_sf_value[N] are further defined. In particular, picture_rsf_value[N] indicates a value of the RSF, and picture_sf_value[N] indicates a value of the SF. A value of N may be 3, which indicates three colour components Y, Cb, and Cr. Alternatively, a value of N may be 2, which indicates two colour channels luma and chroma.

The decoding method provided in embodiments of the disclosure are described in detail above with reference to FIG. 7. An encoding method provided in embodiments of the disclosure will be described in detail below with reference to FIG. 8.

FIG. 8 is a schematic flowchart of an encoding method provided in embodiments of the disclosure. The method in FIG. 8 may also be referred to as a loop filtering method. The method in FIG. 8 may be applied to an encoder, for example, a loop filtering unit in the encoder.

As illustrated in FIG. 8, in operations at S810, a reconstructed picture of an original picture is determined.

In some implementations, the original picture or the reconstructed picture may be a picture.

In some implementations, the original picture or the reconstructed picture may be a block in the picture.

In some implementations, the operations at S810 may include the following. A prediction picture and an inverse-quantized residual picture are determined by performing prediction, transformation, quantization, and inverse quantization on the original picture. Then, the reconstructed picture is determined according to the prediction picture and the residual picture. For example, the reconstructed picture may be the sum of the prediction picture and the residual picture.

In operations at S820, a first residual picture is determined by performing loop filtering on the reconstructed picture according to a neural network.

In some implementations, the neural network may be an HOP.

In some implementations, the neural network may be an LOP.

In some implementations, the operations at S820 may include the following. A filtered picture is determined by performing loop filtering on the reconstructed picture according to the neural network. The first residual picture is determined according to the filtered picture and the reconstructed picture. The filtered picture mentioned herein refers to a picture output by the neural network.

In some implementations, the first residual picture may be determined according to the filtered picture and the reconstructed picture as follows. A difference (i.e., a difference calculated for corresponding pixels) between the filtered picture and the reconstructed picture is determined as the first residual picture.

In operations at S830, multiple output pictures are determined by refining the first residual picture according to multiple candidate values of a first scaling factor.

In operations at S840, a target value of the first scaling factor is determined from the multiple candidate values according to the multiple output pictures.

In some implementations, the first scaling factor may be referred to as an RSF.

In some implementations, the first scaling factor may correspond to one picture. Therefore, the first scaling factor may correspond to a current picture. That is to say, the first scaling factor may be a picture-level scaling factor.

In some implementations, the first scaling factor may correspond to one block in the picture.

In some implementations, the first scaling factor may correspond to one colour component (or colour channel), and different colour components may correspond to different first scaling factors. For example, if colour information of a pixel is represented by three colour components Y, Cb, and Cr, then each of Y, Cb, and Cr may have a corresponding first scaling factor. For another example, if colour information of a pixel is represented by two colour channels: luma and chroma channels, then each of the two colour channels: luma and chroma channels may have a corresponding first scaling factor.

In some implementations, the multiple candidate values of the first scaling factor are predefined values. For example, the number and values of candidate values of the first scaling factor may be agreed upon according to a standard.

In some implementations, the multiple candidate values of the first scaling factor may be determined based on a certain rule. For example, the multiple candidate values of the first scaling factor may be determined based on: a traversal in a value range of the first scaling factor according to a traversal step.

In some implementations, the operations at S840 may include the following. Costs corresponding to the multiple candidate values are determined according to the multiple output pictures and the original picture. The target value is determined from the multiple candidate values according to the costs corresponding to the multiple candidate values. For example, the cost mentioned herein may refer to a distortion cost. After the costs corresponding to the multiple candidate values are determined, a candidate value corresponding to a minimum cost may be determined as the target value of the first scaling factor.

In some implementations, for the above traversal, a certain boundary value (for example, an upper limit value or a lower limit value) of the first scaling factor may be used as an initial value.

Exemplarily, assuming that a value range of an RSF (i.e., the first scaling factor) is (SF_{bottom}, SFᵤₚ) and a traversal step is d, then the number of required traversals is

$$K = \frac{S {F}_{u p} - S {F}_{b o t t o m}}{d}$$

(where if

$$\frac{S {F}_{u p} - S {F}_{b o t t o m}}{d}$$

is not an integer,

$$\frac{S {F}_{u p} - S {F}_{b o t t o m}}{d}$$

may be rounded down), and a candidate value of RSFᵢ obtained in the i-th traversal is SF_{bottom}+i*d. By substituting RSFᵢ into formula 8, an output picture corresponding to RSFᵢ can be obtained. Then, the output picture corresponding to RSFᵢ can be compared with an original picture, and a distortion cost Dᵢ corresponding to RSF; can be calculated.

The minimum distortion cost Dᵢ corresponding to the RSF is calculated through K traversals. Then, a value of the RSF corresponding to the minimum distortion cost Dᵢ may be determined as a target value of the RSF.

The above derivation method may be implemented by using the following pseudo code:

int RSF = 0;
double minD = MAX_DOUBLE;
For (int i=0; i<K; i++)
{
RSFᵢ = SF_{bottom}+ i * d;
outputᵢ = rec + RSFᵢ * (cnn - rec);
Dᵢ = MSE(org, outputᵢ);
if(Dᵢ < minD)
{
minD = Dᵢ;
RSF = RSFᵢ;
}
}

For the meaning of each parameter in the above pseudo code, reference can be made to the related illustration of formulas 1 to 8 above, and MSE(⋅) represents solving a least mean squared error.

In some implementations, the above traversal step may be a fixed step.

In fact, it can be found through the statistical analysis that values of the first scaling factor mainly focus on some specific ranges. Therefore, in some implementations, the traversal step may be set as a non-fixed step (i.e., including traversal steps of non-equal lengths), which can improve flexibility. For example, a value range of the first scaling factor includes a first value interval and a second value interval, the first value interval corresponds to a first traversal step, the second value interval corresponds to a second traversal step, and the first traversal step is different from the second traversal step.

Exemplarily, the first value interval may be a low-frequency range in which the first scaling factor may appear, and the second value interval may be a high-frequency range in which the first scaling factor may appear. For the low-frequency range, a larger traversal step may be set for a coarser-grained search, and for the high-frequency range, a smaller traversal step may be set for a finer-grained search.

As a more specific example, assuming that it is determined through the statistical analysis that a high-frequency range in which a scaling factor may appear is SFᵣ₁~SFᵣ₂, then for an interval SF_{bottom}~SFᵣ₁, d₁(where d₁ is greater than the above fixed step d) may be used as a traversal step, and in this case, RSFᵢ=SF_{bottom}+i*d₁; for an interval SFᵣ₁~SFᵣ₂, d₂ (where d₂ is less than the above fixed step d) may be used as a traversal step, and in this case, RSFᵢ=SFᵣ₁+i*d₂; and for an interval SFᵣ₂~SFᵤₚ, d₁ may be used as a traversal step, and in this case, RSFᵢ=SFᵣ₂+i*d₁. By controlling d₁, d₂, and intervals in the high-frequency range SFᵣ₁~SFᵣ₂, the number of traversals can be kept substantially the same as the number of traversals during the use of the fixed step d, that is, the number of bits that need to be encoded remains unchanged all the time, and the search for an RSF is more finely adjusted, thereby further improving the coding performance.

In some implementations, first information may be signalled into a bitstream.

In some implementations, the first information may be represented by picture_rsf_value.

In some implementations, the first information is the target value of the first scaling factor. That is, a value of the first scaling factor may be directly carried in the bitstream.

In some implementations, the first information may be index information of the target value of the first scaling factor in the multiple candidate values of the first scaling factor. For example, if there are 10 candidate values of the first scaling factor, and the first information is the third value among the 10 candidate values, then a value of the first information may be 3. Compared with directly carrying the value of the first scaling factor in the bitstream, carrying the index information can reduce the number of encoded bits required for carrying the first scaling factor in the bitstream.

In some implementations, the first information indicates the number of traversals corresponding to the first scaling factor (where the number of traversals can be understood as an implementation of the index information). For example, if the encoding end determines candidate values of the first scaling factor based on the above traversal, the first information may indicate the number of traversals corresponding to the first scaling factor. For example, assuming that a candidate value of RSFᵢ obtained in the i-th traversal may be SF_{bottom}+i*d, and a target value of an RSF is a candidate value RSFₖ obtained in the k-th traversal, then the first information may indicate a value of k. As such, at the decoding end, the target value of the RSF may be determined based on SF_{bottom}+k*d.

In the related art, for a calculated value of a scaling factor, N (N=9) bits are needed to directly encode the value of the scaling factor. Different from the related art, the concept of a traversal step is introduced in embodiments of the disclosure. Therefore, a quantization scale may be scaled up, and only the number of traversals needs to be encoded. Compared with directly encoding the value of the scaling factor, encoding the number of traversals can reduce encoded bits required for the scaling factor. For a method for calculating the number of encoded bits for the first scaling factor, reference can be made to formula 11 above.

In some implementations, the operations at S830 may include the following. Multiple refined residual pictures are determined by refining the first residual picture according to the multiple candidate values of the first scaling factor. The multiple output pictures are determined according to the multiple refined residual pictures and the reconstructed picture.

For example, each pixel in the first residual picture may be scaled according to the multiple candidate values of the first scaling factor (i.e., each pixel in the first residual picture is multiplied by the first scaling factor), to determine the multiple refined residual picture (which are in one-to-one correspondence with the multiple candidate values). Then, each of the multiple refined residual pictures may be summed with the reconstructed picture, to determine the multiple output pictures (which are in one-to-one correspondence with the multiple candidate values).

In some implementations, a second residual picture may be determined according to the original picture and the reconstructed picture. Then, a target value of a second scaling factor may be determined according to the first residual picture and the second residual picture. The second scaling factor mentioned herein may refer to a scaling factor provided in the related art, i.e., a scaling factor derived based on the least squares method. For a method for determining the second scaling factor, reference can be made to formulas 1 to 8 above. After the target value of the second scaling factor is determined, a target scaling factor may be determined from the first scaling factor and the second scaling factor according to the target value of the first scaling factor and the target value of the second scaling factor.

For example, first, a first output picture may be determined by refining the first residual picture according to the target value of the second scaling factor. Then, the target scaling factor may be determined from the first scaling factor and the second scaling factor according to the first output picture and a second output picture, where the second output picture corresponds to the target value of the first scaling factor. Exemplarily, a cost (e.g., a distortion cost) corresponding to the first scaling factor may be determined according to the first output picture and the original picture, a cost (e.g., a distortion cost) corresponding to the second scaling factor may be determined according to the second output picture and the original picture, and the target scaling factor may be determined from the first scaling factor and the second scaling factor according to the cost corresponding to the first scaling factor and the cost corresponding to the second scaling factor (for example, a scaling factor corresponding to a minimum cost is determined as the target scaling factor).

In some implementations, second information is signalled into a bitstream. The second information indicates whether the first residual picture is to be refined based on the first scaling factor. In other words, the second information may indicate whether the RSF provided in embodiment of the disclosure is to be used for loop filtering.

In some implementations, for example, the second information may be represented by picture_rsf_enable_flag.

The second information may have a first value and a second value. For example, the first value may be true or 1. The first value may indicate that the first residual picture is to be refined based on the first scaling factor. For example, the second value may be false or 0. The second value may indicate that the first residual picture is not to be refined based on the first scaling factor.

In some implementations, if the first residual picture is not to be refined based on the first scaling factor, the first residual picture may be refined based on a scaling factor provided in the related art. Accordingly, if the second scaling factor is to be used for refining the first residual picture, third information may be signalled into the bitstream, where the third information is a target value of the second scaling factor.

Embodiments of the disclosure will be described in more detail below in combination with a specific example. The following example is applicable to a loop filtering unit at the encoding end. It may be noted that, the following example is merely illustrated for helping those skilled in the art to understand embodiments of the disclosure, and is not intended to limit embodiments of the disclosure to specific values or specific scenarios as illustrated. Apparently, various equivalent modifications or changes can be made by those skilled in the art based on the example illustrated, and those modifications or changes also fall within the scope of embodiments of the disclosure.

A method for refining a picture-level scaling factor is proposed in this solution. Based on the designed traversal and coding algorithm, the picture-level scaling factor is refined, so as to obtain better coding performance.

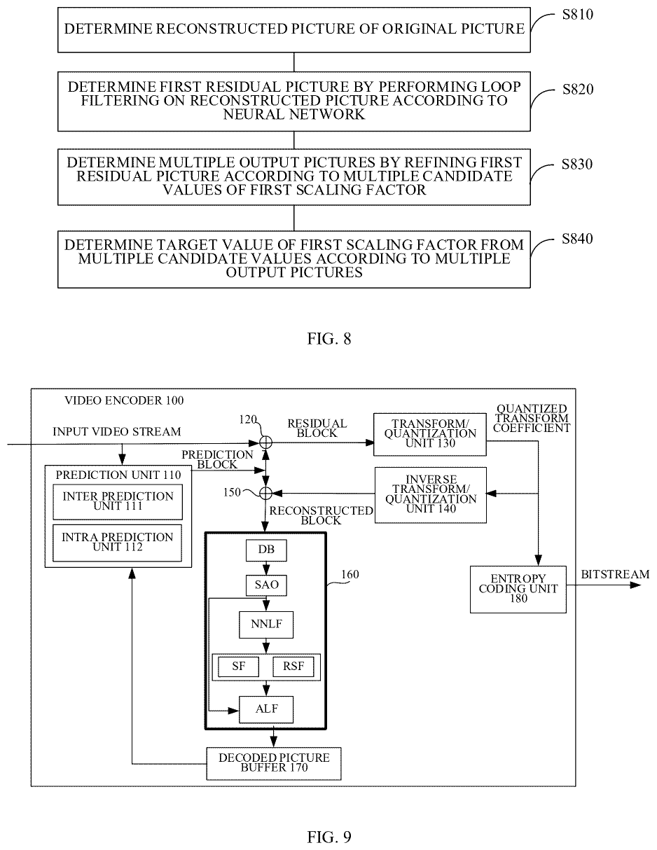

As illustrated in FIG. 9, a scaling-factor refinement unit (i.e., a unit for calculating an RSF) is located in a loop filtering unit 160 of a codec (for the illustration of other units in FIG. 9, reference can be made to FIG. 1). The use of a scaling factor does not rely on the use of a DBF, an SAO, and an ALF. The scaling-factor refinement unit is located after an NNLF and before the ALF.

The scaling-factor refinement unit modifies a method for deriving the scaling factor used by the NNLF. At the encoding end, rate-distortion costs respectively corresponding to the SF and the RSF herein in terms of processing a picture are compared, to determine which scaling factor to use. The selected scaling factor will be signalled into a bitstream for a decoder to read. At the decoder end, when the scaling factor is parsed out, processing is performed on an output picture.

At the encoding end, when the process reaches the loop filtering unit, processing is performed in an order of filters specified. When the process reaches the scaling-factor refinement unit, processing is performed according to the following procedure.

Step a): For a current colour component of a current picture of a current sequence, an SF is determined based on formula 1 to formula 7 by traversing all pixels in a corresponding picture. After step a) is performed, the process proceeds to step b).

Step b): For the current colour component of the current picture of the current sequence, an RSF is determined by traversing all the pixels in the corresponding picture. After step b) is performed, the process proceeds to step c).

Step c): According to the SF, a residual (corresponding to the above first residual picture) between a reconstructed picture and a filtered picture is refined based on formula 8, and according to the RSF, the residual between the reconstructed picture and the filtered picture is refined based on formula 8, to obtain two output pictures. Each of the two output pictures is compared with an original picture, and costs such as distortion costs D are calculated. Two costs are compared. If D_{RSF}<D_{SF}, the RSF is used as a scaling factor finally used for the current colour component of the current picture. Otherwise, if D_{RSF}>=D_{SF}, the SF is used as the scaling factor finally used. After step c) is performed, the process proceeds to step d).

Step d): a picture-level scaling-factor refinement enable flag picture_rsf_enable_flag of the current picture is signalled into a bitstream. If picture_rsf_enable_flag is “1”, a target value picture_rsf_value of the RSF is further encoded. If picture_rsf_enable_flag is “0”, a target value picture_sf_value of the SF is further encoded. After step d) is performed, the process proceeds to step e).

Step e): If the processing of the current picture by the scaling-factor refinement unit has been completed, a next picture is loaded for processing, and the process proceeds to step a).

Test conditions of the above example will be introduced below.

On the basis of an HOP NNLF, the solution herein is implemented based on all types of pictures (including an I picture, a P picture, and a B picture), and the performance is tested. In a specific simulation experiment, a traversal step is set to 5, and in this case, the number of bits required for encoding an RSF is M (M=6).

Under the common test conditions of random access, low delay B (LDB), and all intra configurations, tests are conducted on common sequences specified by the joint video experts team (JVET), and with an SF provided in the related art as a comparison, the performance of part of the sequences is obtained currently. The results are illustrated in table 1, table 2, and table 3.

TABLE 1
performance under random access

| | Random access Main10 | | |
|---|---|---|---|
| | Over NNVC6.0 | | |
| | Y | U | V |
| Class A1 | | | |
| Class A2 | | | |
| Class B | | | |
| Class C | 0.00% | −0.16% | −0.16% |
| Class E | | | |
| Overall | | | |
| Class D | −0.02% | −0.18% | −0.47% |
| Class F | | | |

TABLE 2
performance under all intra

| | All Intra Main10 | | |
|---|---|---|---|
| | Over NNVC6.0 | | |
| | Y | U | V |
| Class A1 | | | |
| Class A2 | | | |
| Class B | | | |
| Class C | −0.02% | 0.06% | 0.06% |
| Class E | | | |
| Overall | | | |
| Class D | −0.01% | −0.04% | 0.00% |
| Class F | | | |

TABLE 3
performance under LDB

| | Low Delay B Main10 | | |
|---|---|---|---|
| | Over NNVC6.0 | | |
| | Y | U | V |
| Class A1 | | | |
| Class A2 | | | |
| Class B | | | |
| Class C | | | |
| Class E | | | |
| Overall | | | |
| Class D | −0.09% | −1.45% | −2.55% |
| Class F | | | |

As can be seen from the analysis of data in the above tables, by introducing the RSF, the coding performance can be further improved on the basis of an NNLF, especially for chroma components under LDB. In addition, this solution does not increase the decoding complexity.

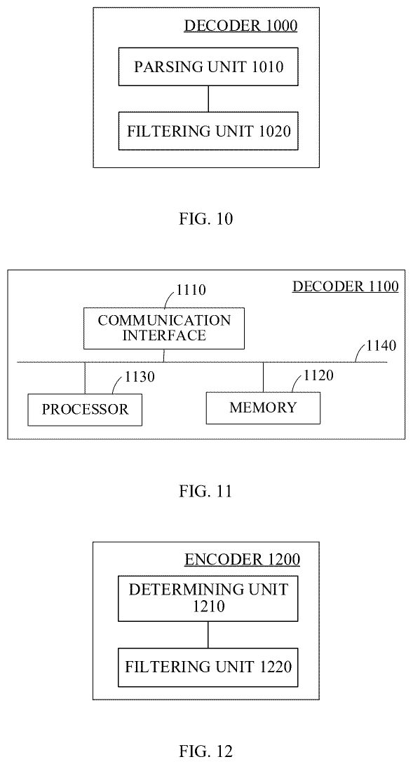

The method embodiments of the disclosure are described in detail above with reference to FIG. 1 to FIG. 9, and apparatus embodiments of the disclosure will be described in detail below with reference to FIG. 10 to FIG. 13. It may be understood that, illustrations of the method embodiments and illustrations of the apparatus embodiments correspond to each other, and therefore, for parts not described in detail, reference can be made to the above method embodiments.

FIG. 10 is a schematic structural diagram of a decoder provided in an embodiment of the disclosure. The decoder 1000 in FIG. 10 includes a parsing unit 1010 and a filtering unit 1020.

The parsing unit 1010 is configured to parse a bitstream to determine first information.

The filtering unit 1020 is configured to determine a target value of a first scaling factor from multiple candidate values of the first scaling factor according to the first information; determine a first residual picture by performing loop filtering on a reconstructed picture according to a neural network; and determine a loop-filtered reconstructed picture by refining the first residual picture according to the target value of the first scaling factor.

In some implementations, the filtering unit 1020 is configured to determine the number of traversals corresponding to the first scaling factor according to the first information; and determine the target value of the first scaling factor according to an initial value of the first scaling factor, a traversal step, and the number of traversals.

In some implementations, a value range of the first scaling factor includes a first value interval and a second value interval, the first value interval corresponds to a first traversal step, the second value interval corresponds to a second traversal step, and the first traversal step is different from the second traversal step.

In some implementations, the first information indicates the number of traversals corresponding to the first scaling factor.

In some implementations, the first information is index information of the target value in the multiple candidate values.

In some implementations, the parsing unit 1010 is further configured to parse the bitstream to determine second information. The second information indicates whether the first residual picture is to be refined based on the first scaling factor.

In some implementations, the second information has a first value and a second value, the first value indicates that the first residual picture is to be refined based on the first scaling factor, and the second value indicates that the first residual picture is not to be refined based on the first scaling factor.

In some implementations, the parsing unit 1010 is further configured to parse the bitstream to determine third information, if a value of the second information is the second value. The third information is a target value of a second scaling factor. A method for determining a value of the second scaling factor is different from a method for determining a value of the first scaling factor.

In some implementations, the filtering unit 1020 is configured to determine a filtered picture by performing loop filtering on the reconstructed picture according to the neural network; and determine the first residual picture according to the filtered picture and the reconstructed picture.

In some implementations, the filtering unit 1020 is configured to determine a refined residual picture by refining the first residual picture according to the target value of the first scaling factor; and determine the loop-filtered reconstructed picture according to the refined residual picture and the reconstructed picture.

In some implementations, the reconstructed picture is a picture or a block in the picture.

It may be understood that in embodiments of the disclosure, the “unit” may be part of the circuitry, part of the processor, part of the program or software, etc., and of course may also be a module, or may be non-modular. In addition, various components described in this embodiment may be integrated into one processing unit or may be present as a number of physically separated units, or two or more units may be integrated into one. The integrated unit may take the form of hardware or a software functional module.

If the integrated unit is implemented as a software functional module and not sold or used as a stand-alone product, the integrated unit may be stored in a computer-readable storage medium. Based on such understanding, the technical solution of this embodiment in essential, or a part that contributes to the prior art, or all or part of the technical solution, may be embodied in the form of a software product. The computer software product is stored in a storage medium and includes a number of instructions to enable a computer device (which may be a personal computer, a server, or a network device, etc.) or processor to perform all or part of the operations of the method described in this embodiment. The foregoing storage medium includes a USB stick, a removable hard disk, a read-only memory (ROM), a random-access memory (RAM), a magnetic disk or an optical disk, and other media that may store program codes.

Thus, embodiments of the disclosure provide a computer-readable storage medium, which is applied to the decoder 1000. The computer-readable storage medium is configured to store a computer program which, when executed by a processor, is operable to implement the decoding method described in the foregoing first embodiment.

Based on the above structure of the decoder 1000 and the computer-readable storage medium, reference is made to FIG. 11 which is a schematic diagram of a specific hardware structure of a decoder 1100 provided in embodiments of the disclosure. As illustrated in FIG. 11, the decoder 1100 may include a communication interface 1110, a memory 1120, and a processor 1130. Various components are coupled together via a bus system 1140. It may be understood that, the bus system 1140 is configured to enable connection and communication between these components. The bus system 1140 includes a power bus, a control bus, and a status signal bus in addition to a data bus. For the sake of clarity, however, the various buses are labelled as bus system 1140 in FIG. 11.

The communication interface 1110 is configured to receive and transmit signals during information transmission with other external network elements.

The memory 1120 is configured to store a computer program.

The processor 1130 is configured to, when executing the computer program, parse a bitstream to determine first information; determine a target value of a first scaling factor from multiple candidate values of the first scaling factor according to the first information; determine a first residual picture by performing loop filtering on a reconstructed picture according to a neural network; and determine a loop-filtered reconstructed picture by refining the first residual picture according to the target value of the first scaling factor.

It will be appreciated that, the memory 1120 in embodiments of the disclosure may be a transitory memory or non-transitory memory, or may include both transitory and non-transitory memory. In particular, the non-transitory memory may be an ROM, a programmable ROM (PROM), an erasable PROM (EPROM), an electrically EPROM (EEPROM), or a flash memory. The transitory memory may be an RAM, which is used as an external cache. By way of illustration, but not limitation, many forms of RAM are available, such as a static RAM (SRAM), a dynamic RAM (DRAM), a synchronous DRAM (SDRAM), a double data rate synchronous random access memory (DDRSDRAM), an enhanced SDRAM (ESDRAM), a synchlink DRAM (SLDRAM), and a direct Rambus RAM (DRRAM). The memory 1120 of the system and method described in this disclosure is intended to include, but is not limited to, these and any other suitable types of memory.

The processor 1130 may be an integrated circuit chip with signal processing capabilities. During implementation, the operations in the above method may be accomplished by integrated logic circuitry in the hardware of the processor 1130 or by instructions in the form of software. The processor 1130 described above may be a general-purpose processor, a digital signal processor (DSP), an application specific integrated circuit (ASIC), a field programmable gate array (FPGA), or other programmable logic device, discrete gate or transistor logic device, discrete hardware component. The various methods, steps and logic block diagrams disclosed in embodiments of the disclosure may be implemented or performed. The general-purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the memory 1120, and the processor 1130 reads the information in the memory 1120 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSP Device (DSPD), programmable logic device (PLD), FPGA, general-purpose processor, controller, microcontroller, microprocessor, other electronic unit for performing the functions described in this disclosure, or a combination thereof. For software implementations, the technology described in this disclosure may be implemented by means of modules (e.g. procedures, functions, etc.) that perform the functions described in this disclosure. The software code may be stored in a memory and executed by a processor. The memory may be implemented in the processor or outside the processor.

Optionally, as another embodiment, the processor 1130 is further configured to perform the decoding method described in the foregoing embodiment when executing the computer program.

FIG. 12 is a schematic structural diagram of an encoder provided in an embodiment of the disclosure. As illustrated in FIG. 12, the encoder 1200 includes a determining unit 1210 and a filtering unit 1220.

The determining unit 1210 is configured to determine a reconstructed picture of an original picture.

The filtering unit 1220 is configured to determine a first residual picture by performing loop filtering on the reconstructed picture according to a neural network; determine multiple output pictures by refining the first residual picture according to multiple candidate values of a first scaling factor; and determine a target value of the first scaling factor from the multiple candidate values according to the multiple output pictures.

In some implementations, the multiple candidate values are determined based on: a traversal in a value range of the first scaling factor according to a traversal step.

In some implementations, the value range of the first scaling factor includes a first value interval and a second value interval, the first value interval corresponds to a first traversal step, the second value interval corresponds to a second traversal step, and the first traversal step is different from the second traversal step.

In some implementations, the encoder 1200 further includes a first encoding unit. The first encoding unit is configured to signal first information into a bitstream. The first information indicates the number of traversals corresponding to the first scaling factor.

In some implementations, the filtering unit 1220 is further configured to determine a second residual picture according to the original picture and the reconstructed picture; determine a target value of a second scaling factor according to the first residual picture and the second residual picture; and determine a target scaling factor from the first scaling factor and the second scaling factor according to the target value of the first scaling factor and the target value of the second scaling factor.

In some implementations, the filtering unit 1220 is configured to determine a first output picture by refining the first residual picture according to the target value of the second scaling factor; and determine the target scaling factor from the first scaling factor and the second scaling factor according to the first output picture and a second output picture. The second output picture corresponds to the target value of the first scaling factor.

In some implementations, the filtering unit 1220 is configured to determine a cost corresponding to the first scaling factor according to the first output picture and the original picture; determine a cost corresponding to the second scaling factor according to the second output picture and the original picture; and determine the target scaling factor from the first scaling factor and the second scaling factor according to the cost corresponding to the first scaling factor and the cost corresponding to the second scaling factor.

In some implementations, the encoder 1200 further includes a second encoding unit. The second encoding unit is configured to signal first information into a bitstream. The first information is index information of the target value in the multiple candidate values.

In some implementations, the encoder 1200 further includes a third encoding unit. The third encoding unit is configured to signal second information into a bitstream. The second information indicates whether the first residual picture is to be refined based on the first scaling factor.

In some implementations, the second information has a first value and a second value, the first value indicates that the first residual picture is to be refined based on the first scaling factor, and the second value indicates that the first residual picture is not to be refined based on the first scaling factor.

In some implementations, if a value of the second information is the second value, third information is signalled into the bitstream. The third information is a target value of a second scaling factor, the second scaling factor is determined based on the first residual picture and a second residual picture, and the second residual picture is determined based on the original picture and the reconstructed picture.

In some implementations, the filtering unit 1220 is configured to determine a filtered picture by performing loop filtering on the reconstructed picture according to the neural network; and determine the first residual picture according to the filtered picture and the reconstructed picture.

In some implementations, the filtering unit 1220 is configured to determine multiple refined residual pictures by refining the first residual picture according to the multiple candidate values of the first scaling factor; and determine the multiple output pictures according to the multiple refined residual pictures and the reconstructed picture.

In some implementations, the filtering unit 1220 is configured to determine costs corresponding to the multiple candidate values according to the multiple output pictures and the original picture; and determine the target value from the multiple candidate values according to the costs corresponding to the multiple candidate values.

In some implementations, the reconstructed picture is a picture or a block in the picture.

It may be understood that in embodiments of the disclosure, the “unit” may be part of the circuitry, part of the processor, part of the program or software, etc., and of course may also be a module, or may be non-modular. In addition, various components described in this embodiment may be integrated into one processing unit or may be present as a number of physically separated units, or two or more units may be integrated into one. The integrated unit may take the form of hardware or a software functional module.

If the integrated unit is implemented as a software functional module and not sold or used as a stand-alone product, the integrated unit may be stored in a computer-readable storage medium. Based on such understanding, the technical solution of this embodiment in essential, or a part that contributes to the prior art, or all or part of the technical solution, may be embodied in the form of a software product. The computer software product is stored in a storage medium and includes a number of instructions to enable a computer device (which may be a personal computer, a server, or a network device, etc.) or processor to perform all or part of the operations of the method described in this embodiment. The foregoing storage medium includes a USB stick, a removable hard disk, an ROM, an RAM, a magnetic disk or an optical disk, and other media that may store program codes.

Thus, embodiments of the disclosure provide a computer-readable storage medium, which is applied to the encoder 1200. The computer-readable storage medium is configured to store a computer program which, when executed by a processor, is operable to implement the decoding method described in any one of the foregoing embodiments.

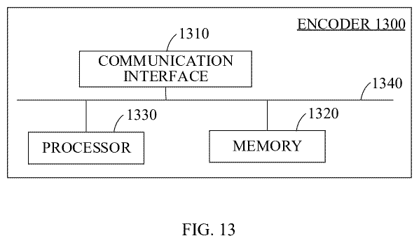

Based on the above structure of the encoder 1200 and the computer-readable storage medium, reference is made to FIG. 13 which is a schematic diagram of a specific hardware structure of an encoder 1300 provided in embodiments of the disclosure. As illustrated in FIG. 13, the encoder 1300 may include a communication interface 1310, a memory 1320, and a processor 1330. Various components are coupled together via a bus system 1340. It may be understood that, the bus system 1340 is configured to enable connection and communication between these components. The bus system 1340 includes a power bus, a control bus, and a status signal bus in addition to a data bus. For the sake of clarity, however, the various buses are labelled as bus system 1340 in FIG. 13.

The communication interface 1310 is configured to receive and transmit signals during information transmission with other external network elements.

The memory 1320 is configured to store a computer program.

The processor 1330 is configured to, when executing the computer program, determine a reconstructed picture of an original picture; determine a first residual picture by performing loop filtering on the reconstructed picture according to a neural network; determine multiple output pictures by refining the first residual picture according to multiple candidate values of a first scaling factor; and determine a target value of the first scaling factor from the multiple candidate values according to the multiple output pictures.

It will be appreciated that, the memory 1320 in embodiments of the disclosure may be a transitory memory or non-transitory memory, or may include both transitory and non-transitory memory. In particular, the non-transitory memory may be an ROM, a PROM, an EPROM, an EEPROM, or a flash memory. The transitory memory may be an RAM, which is used as an external cache. By way of illustration, but not limitation, many forms of RAM are available, such as an SRAM, a DRAM, an SDRAM, a DDRSDRAM, an ESDRAM, an SLDRAM, and a DRRAM. The memory 1320 of the system and method described in this disclosure is intended to include, but is not limited to, these and any other suitable types of memory.

The processor 1330 may be an integrated circuit chip with signal processing capabilities. During implementation, the operations in the above method may be accomplished by integrated logic circuitry in the hardware of the processor 1330 or by instructions in the form of software. The processor 1330 described above may be a general-purpose processor, a DSP, an ASIC, an FPGA, or other programmable logic device, discrete gate or transistor logic device, discrete hardware component. The various methods, steps and logic block diagrams disclosed in embodiments of the disclosure may be implemented or performed. The general-purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the memory 1320, and the processor 1330 reads the information in the memory 1320 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSPD, PLD, FPGA, general-purpose processor, controller, microcontroller, microprocessor, other electronic unit for performing the functions described in this disclosure, or a combination thereof. For software implementations, the technology described in this disclosure may be implemented by means of modules (e.g. procedures, functions, etc.) that perform the functions described in this disclosure. The software code may be stored in a memory and executed by a processor. The memory may be implemented in the processor or outside the processor.

Optionally, as another embodiment, the processor 1330 is further configured to perform the encoding method described in the foregoing embodiment when executing the computer program.

It may be noted that in this disclosure, the terms “include”, “comprise” or any other variant thereof are intended to cover non-exclusive inclusion, such that a process, method, article or apparatus comprising a range of elements includes not only those elements, but also includes other elements that are not explicitly listed or are also inherent to such a process, method, article or apparatus. Without further limitation, an element qualified by the statement “including a . . . ” does not preclude the existence of another identical element in the process, method, article or apparatus including that element.

The above serial numbers of the embodiments of the disclosure are for descriptive purposes only and do not represent the merits of the embodiments.

The methods disclosed in the several method embodiments provided in this disclosure may be combined in any way to obtain new method embodiments without conflict.

The features disclosed in the several product embodiments provided in this disclosure may be combined in any way to obtain new product embodiments without conflict.

The features disclosed in several method or apparatus embodiments provided in this disclosure may be combined in any way to obtain new method embodiments or apparatus embodiments without conflict.

The foregoing is only a specific implementation of the present disclosure, but the scope of protection of the present disclosure is not limited thereto, and any variation or substitution readily conceivable by any person skilled in the art within the technical scope disclosed in the present disclosure shall be covered by the scope of protection of the present disclosure. Accordingly, the scope of protection of this disclosure shall be governed by the scope of protection of the stated claims.

What is claimed is:

1. A decoding method, applied to a decoder and comprising:
parsing a bitstream to determine first information;
determining a target value of a first scaling factor from a plurality of candidate values of the first scaling factor according to the first information;
determining a first residual picture by performing loop filtering on a reconstructed picture according to a neural network; and
determining a loop-filtered reconstructed picture by refining the first residual picture according to the target value of the first scaling factor.

2. The method of claim 1, wherein determining the target value of the first scaling factor from the plurality of candidate values of the first scaling factor according to the first information comprises:
determining a number of traversals corresponding to the first scaling factor according to the first information; and
determining the target value of the first scaling factor according to an initial value of the first scaling factor, a traversal step, and the number of traversals.

3. The method of claim 2, wherein a value range of the first scaling factor comprises a first value interval and a second value interval, the first value interval corresponds to a first traversal step, the second value interval corresponds to a second traversal step, and the first traversal step is different from the second traversal step.

4. The method of claim 1, wherein the first information is index information of the target value in the plurality of candidate values.

5. The method of claim 1, further comprising:
parsing the bitstream to determine second information, wherein the second information indicates whether the first residual picture is to be refined based on the first scaling factor.

6. The method of claim 5, wherein the second information has a first value and a second value, the first value indicates that the first residual picture is to be refined based on the first scaling factor, and the second value indicates that the first residual picture is not to be refined based on the first scaling factor.

7. The method of claim 6, wherein in response to a value of the second information being the second value, the method further comprises:
parsing the bitstream to determine third information, wherein the third information is a target value of a second scaling factor.

8. The method of claim 1, wherein determining the first residual picture by performing loop filtering on the reconstructed picture according to the neural network comprises:
determining a filtered picture by performing loop filtering on the reconstructed picture according to the neural network; and
determining the first residual picture according to the filtered picture and the reconstructed picture.

9. The method of claim 1, wherein determining the loop-filtered reconstructed picture by refining the first residual picture according to the target value of the first scaling factor comprises:
determining a refined residual picture by refining the first residual picture according to the target value of the first scaling factor; and
determining the loop-filtered reconstructed picture according to the refined residual picture and the reconstructed picture.

10. The method of claim 1, wherein the reconstructed picture is a picture or a block in the picture.

11. An encoding method, applied to an encoder and comprising:
determining a reconstructed picture of an original picture;
determining a first residual picture by performing loop filtering on the reconstructed picture according to a neural network;
determining a plurality of output pictures by refining the first residual picture according to a plurality of candidate values of a first scaling factor; and
determining a target value of the first scaling factor from the plurality of candidate values according to the plurality of output pictures.

12. The method of claim 11, wherein the plurality of candidate values are determined based on:
a traversal in a value range of the first scaling factor according to a traversal step.

13. The method of claim 12, wherein the value range of the first scaling factor comprises a first value interval and a second value interval, the first value interval corresponds to a first traversal step, the second value interval corresponds to a second traversal step, and the first traversal step is different from the second traversal step.

14. The method of claim 12, further comprising:
signalling first information into a bitstream, wherein the first information indicates a number of traversals corresponding to the first scaling factor.

15. The method of claim 11, further comprising:
determining a second residual picture according to the original picture and the reconstructed picture;
determining a target value of a second scaling factor according to the first residual picture and the second residual picture; and
determining a target scaling factor from the first scaling factor and the second scaling factor according to the target value of the first scaling factor and the target value of the second scaling factor.

16. The method of claim 15, wherein determining the target scaling factor from the first scaling factor and the second scaling factor according to the target value of the first scaling factor and the target value of the second scaling factor comprises:
determining a first output picture by refining the first residual picture according to the target value of the second scaling factor; and
determining the target scaling factor from the first scaling factor and the second scaling factor according to the first output picture and a second output picture, wherein the second output picture corresponds to the target value of the first scaling factor.

17. The method of claim 16, wherein determining the target scaling factor from the first scaling factor and the second scaling factor according to the first output picture and the second output picture comprises:
determining a cost corresponding to the first scaling factor according to the first output picture and the original picture;
determining a cost corresponding to the second scaling factor according to the second output picture and the original picture; and
determining the target scaling factor from the first scaling factor and the second scaling factor according to the cost corresponding to the first scaling factor and the cost corresponding to the second scaling factor.

18. The method of claim 11, further comprising:
signalling first information into a bitstream, wherein the first information is index information of the target value in the plurality of candidate values.

19. A decoder, comprising:
at least one processor; and
a memory coupled to the at least one processor and storing at least one computer executable instruction thereon which, when executed by the at least one processor, causes the at least one processor to:
parse a bitstream to determine first information; and
determine a target value of a first scaling factor from a plurality of candidate values of the first scaling factor according to the first information; determine a first residual picture by performing loop filtering on a reconstructed picture according to a neural network; and determine a loop-filtered reconstructed picture by refining the first residual picture according to the target value of the first scaling factor.

20. A non-transitory computer-readable storage medium storing a computer program and a bitstream, wherein when executed by a processor, the computer program causes the processor to implement the encoding method of claim 11 generate the bitstream.
